(19) United States
(12) Patent Application Publication
(10) Pub. No.: US 2022/0398419 A1
(43) Pub. Date: Dec. 15, 2022

(54) AUTOMATED CALIBRATION AND OPTIMIZED PATCH SET CREATION FOR VOID PANTOGRAPH

(71) Applicant: Xerox Corporation, Norwalk, CT (US)

(72) Inventors: Jonathan Ross Ireland, Lancaster, PA (US); Stuart Schweid, Pittsford, NY (US)

(21) Appl. No.: 17/344,120

(22) Filed: Jun. 10, 2021

(51) Int. Cl. G06K 15/02; H04N 1/32; H04N 1/405

(52) U.S. Cl. CPC G06K 15/027; H04N 1/32149; G06K 15/1881; H04N 1/405

(57) ABSTRACT

Methods and systems for creating a security mark for a document. A first generation print can be rendered based on one or more patterns (e.g., pantograph pattern) for a security mark. Post-copy results of the pattern(s) can be then rendered. The first generation print and the post-copy results of the pattern(s) can be calibrated, and the output of the calibration of the first generation print and the post-copy results are then applicable for optimizing the design of the security mark for a print condition. Optimization of the design of the security mark for the print condition can be implemented by applying the output of the calibrating of the first generation print and the post-copy results for the print condition. The first generation prints and post-copy results of pantograph pattern samples can be calibrated to drastically reduce the time and labor involved in optimizing void pantograph designs for a particular print condition.

### TECHNICAL FIELD

Embodiments are generally related to the field of security for document printing applications. Embodiments also relate to pantographs and void pantographs for authenticating and securing documents. Embodiments further relate to systems and methods for automatically calibrating first generation prints and post-copy results of pantograph pattern samples to drastically reduce the time and labor involved in optimizing void pantograph designs for a particular print condition.

### BACKGROUND

As the quality of color copiers has improved, it has become easier to generate copies of a document that may be indistinguishable from the original document. In many instances, the unauthorized copying of document content can result in serious implications. For example, there is a concern that color copiers could be used to reproduce security documents, such as checks, stock certificates, automobile title instruments, and other documents of value, for illegal purposes.

One approach for authenticating documents and reducing unauthorized copying involves the use of what is commonly referred to as a void pantograph. Conventional techniques for creating pantographs can involve forming printed dots (or other elements) of two different sizes and frequencies, which are used to create regions of similar tone, corresponding to a textual warning and background, respectively, in an original (authentic) document. Note that the term ‘tone’ can refer to the visual appearance produced by halftone dots, bars, or marks which may cover at least a portion of a printed area and which usually have a frequency that can be measured in dots, lines, or marks per inch. To provide a constant tone, the smaller elements may have a higher frequency than the larger elements. Because the tone of the textual warning and the tone of the background pattern can be selected to be substantially the same, these two regions may have a similar visual impact on an observer of the original document, and the textual warning may not be readily perceived.

Upon copying, however, the situation can change. Since the response of an image sensor employed in a scanner, for example, is different from the response of the human visual system, changes in the relative tone of the two different areas may appear. These changes may be due to the different frequency responses of the sensor (with respect to the human eye) and also due to other, normally non-linear, effects, such as a detection floor or threshold, where signals below a certain level may be simply “lost.”

In general, the high frequency components can be more strongly affected and attenuated. The difference in response of the scanner can express itself as a relative change in tone in the copy and thus the hitherto invisible textual warning becomes visible. For example, in the resulting copy, only the larger printed dots are apparent. These larger dots can spell out the word “void,” for example, or another pre-determined textual warning.

In current techniques, the pantograph can be applied to the substrate to create a pre-printed carrier. An image to be protected can be then applied to the pre-printed carrier. These methods have generally been successful in protecting documents, and are sometimes combined with other techniques, such as the use of camouflage patterns, and the like. However, they are static in nature and thus in general are limited to generally valid, partly nondescript words like “void” or “copy.” Void pantographs are thus a well-known technique, which can be used for fraud protection.

Void Pantographs are commonly implemented by filling a word such as “VOID” or “COPY” with a certain ink and tone value of a first halftone pattern, against a background field of a second, different ink and tone value of a second, different halftone pattern, such that the visual appearance after first generation print for a particular print condition (e.g., imaging device+media+drop or spot size+quality setting, etc.) makes it difficult to see the word VOID or COPY, but after copying on one or more different copiers at different copy settings, the word VOID or COPY will be revealed, indicating that this copied result is NOT a legitimate original.

The process to find first the pairs of tone value that satisfy the “well-hiding-in-original-print” condition, and OF THOSE, to find those satisfying the “are revealed strongly after copying on a particular copier” has been exceedingly time and labor intensive. Typically, this process has been as follows:

1) Print using a single print condition (e.g., printer, media, drop or spot size, quality settings, etc.) a large sample of individual sample patches each containing a single pair of varied tone values of “Haftone one (H1) ” and “Halftone two (H2)” Since It is typically not possible to predict in advance what relative values of H1 and H2 when paired are visually well hiding, many such pairs for each tone level must be tested, for example, 5-10, 6-10, 7-10, 8-10, 9-10, 11-10, 12-10, 13-10, 14-10, 15-10, (i.e., repeat for every tone value) etc.

2) Visually review all these patches as originally printed and manually record those that are well-hiding.

3) Take the many samples and also copy them on various copiers and settings. Note: every COPY instance multiplies the sheets to be manually reviewed in the next step.

4) Keep track of which samples passed as well-hiding in step 2, review copies made in step 3 and then look for examples that were strongly revealed. Results are compiled across copier/copier settings instances and “winning” combinations are selected, which were strongly revealed on the most copier settings, or were revealed strongly for a particular copier (in some cases, it becomes necessary to include multiple pantograph styles in a single document to “defeat” an entire suite of copiers)

5) Repeat this exercise for additional halftone designs

6) Repeat this exercise for additional colors

7) Repeat this exercise for additional media.

It is easy to appreciate that this approach can quickly become a very time- and labor-intensive exercise as presently practiced.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved security for document printing applications.

It is another aspect of the disclosed embodiments to provide for methods and systems for the creation of improved pantographs and void pantographs for authenticating and securing documents.

It is a further aspect of the disclosed embodiments to provide for improved methods and systems for creating a security mark (e.g., a pantograph) for a document.

It is a further aspect of the disclosed embodiments to provide for methods and systems for automatically calibrating first generation prints and post-copy results of pantograph pattern samples to drastically reduce the time and labor involved in optimizing pantograph designs for a particular print condition, as compared to conventional solutions.

The aforementioned aspects and other objectives and advantages can now be achieved as described herein. In an embodiment, a method for creating a security mark for a document, can involve: rendering a first generation print based on at least one pattern for a security mark; rendering post-copy results of the at least one pattern; and calibrating the first generation print and the post-copy results of the at least one pattern, wherein an output of the calibrating of the first generation print and the post-copy results is applicable for optimizing a design of the security mark for a print condition.

An embodiment of the method can further involve optimizing the design of the security mark for a print condition by applying the output of the calibrating of the first generation print and the post-copy results for the print condition.

An embodiment of the method can further involve rendering a first generation print based on the at least one pattern for a security mark, further comprises: printing a first patch at multiple grey levels using a first halftone.

An embodiment of the method can further involve rendering post-copy results of the at least one pattern, further comprises: printing a second patch at multiple grey levels using a second haltone.

In an embodiment, the first generation print and the post-copy results of the at least one pattern, can further involve: copying a first printed page comprising the first patch using a target copier; copying a second printed page comprising the second patch using the target copier; measuring a response of the first printed page including the first patch and the second printed page including the second patch; determining all grey levels having a minimal visual difference with respect to each of the first patch and second patch; and determining which grey levels have a large visual difference with respect to each of the first patch and second patch when measured with copies of the first printed page and the second printed page.

An embodiment of the method can further involve selecting a plurality of pantograph halftone grey levels for optimizing a design of the security mark for a print condition based on the determined grey levels having the large visual difference.

In another embodiment, a system for creating a security mark for a document, can include at least one processor, and a non-transitory computer-usable medium embodying computer program code. The computer-usable medium is operable for communicating with the at least one processor. The computer program code can include instructions executable by the at least one processor and configured for: rendering a first generation print based on at least one pattern for a security mark; rendering post-copy results of the at least one pattern; and calibrating the first generation print and the post-copy results of the at least one pattern, wherein an output of the calibrating of the first generation print and the post-copy results is applicable for optimizing a design of the security mark for a print condition.

In an embodiment of the system, the instructions executable by the at least one processor can be further configured for: optimizing the design of the security mark for a print condition by applying the output of the calibrating of the first generation print and the post-copy results for the print condition.

In an embodiment of the system, the instructions executable by the at least one processor can be further configured for: rendering a first generation print based on the at least one pattern for a security mark, further comprises: printing a first patch at multiple grey levels using a first halftone.

In an embodiment of the system, the instructions executable by the at least one processor can be further configured for: rendering post-copy results of the at least one pattern, further comprises: printing a second patch at multiple grey levels using a second haltone.

In an embodiment of the system, the instructions configured for calibrating the first generation print and the post-copy results of the at least one pattern, can further comprise instructions configured for: copying a first printed page comprising the first patch using a target copier; copying a second printed page comprising the second patch using the target copier; measuring a response of the first printed page including the first patch and the second printed page including the second patch; determining all grey levels having a minimal visual difference with respect to each of the first patch and second patch; and determining which grey levels have a large visual difference with respect to each of the first patch and second patch when measured with copies of the first printed page and the second printed page.

In an embodiment of the system, the instructions executable by the at least one processor can be further configured for: selecting a plurality of pantograph halftone grey levels that optimize a design of the security mark for a print condition based on the determined grey levels having the large visual difference.

In another embodiment, an apparatus that provides security for a document, can include: a security mark based on a first generation print rendered based on at least one pattern for a security mark and further based on post-copy results rendered of the at least one pattern, wherein the output of a calibration of the first generation print and the post-copy results can be applicable for optimizing the design of the security mark for a print condition.

In an embodiment of the apparatus, the design of the security mark for a print condition can be optimized by applying the output of the calibration of the first generation print and the post-copy results for the print condition.

In an embodiment of the apparatus, the first generation print based on the at least one pattern for a security mark can be rendered by printing a first patch at multiple grey levels using a first halftone.

In an embodiment of the apparatus, the first generation print based on the at least one pattern for a security mark, can be rendered by printing a first patch at multiple grey levels using a first halftone, and the post-copy results of the at least one pattern can be rendered by printing a second patch at multiple grey levels using a second haltone.

In an embodiment of the apparatus, the calibration of the first generation print and the post-copy results of the at least one pattern can be achieved by copying a first printed page comprising the first patch using a target copier; copying a second printed page comprising the second patch using the target copier; measuring a response of the first printed page including the first patch and the second printed page including the second patch; determining all grey levels having a minimal visual difference with respect to each of the first patch and second patch; and determining which grey levels have a large visual difference with respect to each of the first patch and second patch when measured with copies of the first printed page and the second printed page.

In an embodiment of the apparatus, a plurality of pantograph halftone grey levels can be selectable for optimizing the design of the security mark for the print condition based on the determined grey levels having the large visual difference.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram including various elements of equipment that may be included with and/or used by a document validation system, in accordance with an example embodiment;

FIG. 2 illustrates a block diagram depicting various elements of an example of a computing device, which can be adapted for use in accordance with an example embodiment;

FIG. 3 illustrates a flow chart of operations depicting logical operational steps of a method for automated calibration optimized patch set creation for a void pantograph, in accordance with an embodiment;

FIG. 4 illustrates a flow chart of operations depicting logical operational steps of another method for automated calibration optimized patch set creation for a void pantograph, in accordance with another embodiment;

FIG. 5 illustrates an image representative of a well-hiding and strongly-revealing pantograph using black ink, tones of 29% and 22%, and two different halftones, and a particular media and drop size, in accordance with an embodiment;

FIG. 6 illustrates an image representative of the historically time- and labor-intensive process, in which a partial set of original prints with several “well-hiding” swatches selected after manual visual evaluation;

FIG. 7 illustrates an image demonstrating the use of the prior process, in the back a selection of well-hidden Halftone pairs strongly revealed on a particular black and white copier, and on top of that those same pairs showing as strongly revealed on a particular color copier; and

FIG. 8 illustrates an image of one set of copy samples after discarding HALF as poor performers.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment”, “in an embodiment”, “in an example embodiment”, or “in some embodiments” and variations thereof as utilized herein may or may not necessarily refer to the same embodiment. The phrase “in another embodiment”, “in another example embodiment”, or “in an alternative embodiment” and variations thereof as utilized herein may or may not necessarily refer to a different embodiment. It is intended, for example, that claimed subject matter may include combinations of embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense.

In addition, the terms “one or more” or “at least one” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

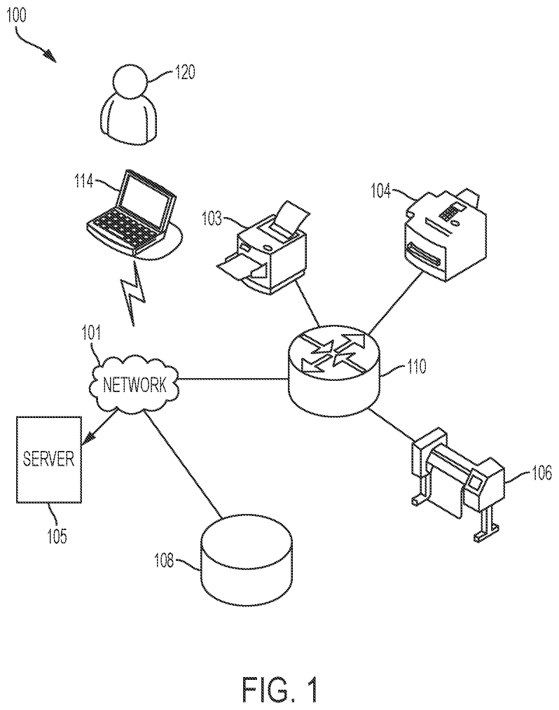

FIG. 1 illustrates a block diagram including various elements of equipment that may be included with and/or used by a document validation system 100 for the validation of a certified document, in accordance with an embodiment. The system 100 can include or can be connected to one or more networks 101. As used in this document, the term “connected” refers to any configuration in which two or more devices may share data, programming instructions, or other electronic communications with each other via wired and/or wireless communications. A user 120 can access the document validation system 100 by one or more computing devices 114, which may execute programming instructions including steps or operations to implement the processes and methods described herein, or which may contain and execute software (such as a browser or other portal software) that can allow a user to access the document validation system 100 as executed by an external computing device.

Any number of image capture devices (e.g., copier, scanner, a card scanner, flatbed image scanner, MFD (Multi-Function Device), or similar device) 103, print devices 104 and 106, and other devices may be connected to network 101 either directly or indirectly (e.g., via a router or other connecting device). A networking device 110 such as a router may serve as a device to route information received via the network 101 to an appropriate print device. Networking device 110 may be any device capable of forwarding, routing, or otherwise transmitting packets and/or messages through a network, and any number of networking devices may be positioned within or on either side of network 101. A computer server 105 can also be implemented, which communicates with the network 105. In some cases, the network 105 can maintain the database 108 in a memory of the server 105 or the database 108 may be located or maintained elsewhere. It should be appreciated that print devices 103 or 104 in some embodiments may be MFDs with scanning capabilities or may be photocopy machines with scanning and printing capabilities and so on. In any event, print devices 103, 104 or devices such as scan can be used to scan documents having the disclosed pantograph(s). Note that as utilized herein, the term ‘pantograph’ relates to a security mark for a document. An example of a pantograph is a void pantograph as discussed in more detail herein.

The document validation system 100 also can include one or more data storage facilities 108, such as a database that resides in a computer-readable memory and serves as a document repository that includes various data files corresponding to documents, document templates, and/or security templates (including security elements) that may be available for validation of a secured document. The data storage facilities 108 may include memory portions that are physically separate from the user's computing device 114 as shown, and/or they may include memory portions that are part of the user's computing device 114.

In certain embodiments, the data files may include copies of secure documents and/or document templates generated by an author from a computing device included in the document validation system 100, and sent to a recipient as an electronic document or a hard copy document. For example, a secured document may be mailed or e-mailed to a recipient with the expectation of receiving the secured document back at some point in the future, potentially with additional information added to the secured document. Examples may include bank checks, diploma certificates, tickets, permits, deeds, and other such documents sent to the respective issuing authority (primary recipient). In certain embodiments, the primary recipient may provide the document validation system 100 with data regarding potential secondary recipients, which may include name, address, e-mail, and other contact and permission information. Such information may also be stored as data files in the data storage facilities 108.

The systems described in this document may include implementations that are embodied in a print device, an image capture device, a computing device with a connected print device, a software program, a cloud based system, or any combination of these items.

There are many situations in which a user may require a secured copy of a document. A secured copy is a printed document that contains one or more security elements that serve as an indicator that the document was generated by an authorized entity. The authorized entity may be a federal, state, or local government agency, or an entity to whom authorization may be delegated, such as an automobile association or notary public. The document validation system 100 can enable individuals who are not necessarily familiar with the location and/or identity of the security elements included in a document, in verifying the authenticity of the document.

The document validation system 100 can be implemented as an apparatus that can provide security for a document. Such an apparatus may include or provide a security mark (e.g., pantograph) based on a first generation print rendered based on at least one pattern for a security mark and further based on post-copy results rendered of the at least one pattern (e.g. such as a voice pantograph pattern). The output of a calibration of the first generation print and the post-copy results can be applicable for optimizing the design of the security mark for a print condition as discussed in more detail below.

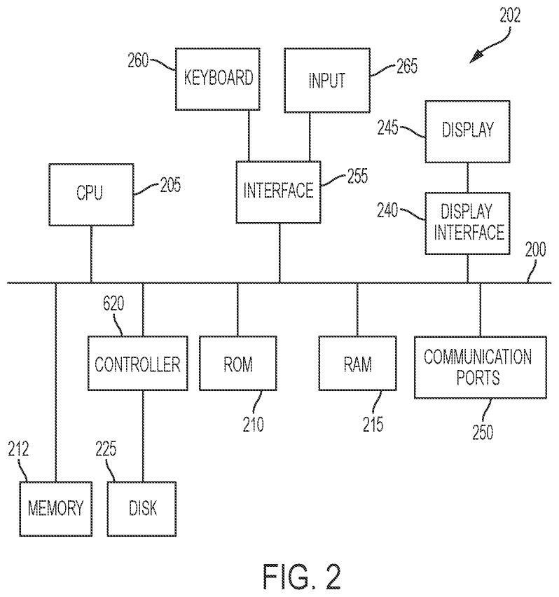

FIG. 2 depicts a block diagram of an example of a data-processing system 202 including internal hardware that may be used to contain or implement program instructions, such as the process steps discussed herein, according to example embodiments. Note that the data-processing system 202 can be implemented as, for example, the server 105 shown in FIG. 1, which can communicate with the network 101 and/or maintain the database 108 of FIG. 1 in a memory such as, for example, memory 212 shown in FIG. 2. The data-processing system 202 may also be, for example, a computing device such as the computing device 114 shown in FIG. 1.

A bus 200 can serve as an information highway interconnecting the other illustrated components of the hardware. CPU 205 can represent one or more processors of the system, performing calculations and logic operations required to execute a program. CPU 205, alone or in conjunction with one or more of the other elements disclosed in FIG. 2, is an example of a processing device, computing device, or processor as such terms are used within this disclosure. Read only memory (ROM) 210 and random access memory (RAM) 215 constitute examples of memory devices or processor-readable storage media.

A controller 220 can interface with one or more optional tangible, computer-readable memory devices 212 to the system bus 200. These memory devices 212 may include, for example, an external or internal disk drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 210 and/or the RAM 215. Optionally, the program instructions may be stored on a tangible computer readable medium 225 such as a compact disk, a digital disk, flash memory, a memory card, a USB drive, an optical disc storage medium, and/or other recording medium controlled via a disk controller 620

An optional display interface 240 may permit information from the bus 200 to be displayed on the display 245 in audio, visual, graphic, or alphanumeric format. Communication with external devices, such as a printing device, may occur using various communication ports 250. A communication port 250 may be attached to a communications network, such as the Internet or an intranet.

The hardware may also include an interface 255 which allows for receipt of data from input devices such as a keyboard 260 or other input device 265 such as a mouse, a joystick, a touch screen, a remote control, a pointing device, a video input device, and/or an audio input device.

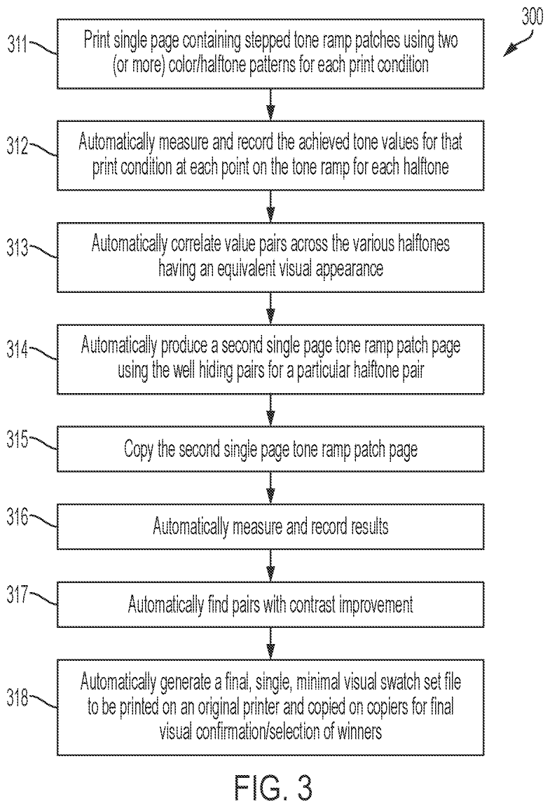

FIG. 3 illustrates a flow chart of operations depicting logical operational steps of a method 300 for automated calibration optimized patch set creation for a void pantograph, in accordance with an embodiment. As indicated at block 310, a step or operation can be implemented to print a single page containing stepped tone ramp patches using the two (or more) color/halftone patterns for each print condition (e.g., media, drop, etc.). For the operation shown at block 311, a patch layout can be used, for example, X-Rite ISIS, for automatic reading and recording. Thereafter, as shown at block 312, a step or operation can be implemented to automatically measure and record the ACHIEVED tone values for that print condition at each point on the tone ramp for each halftone (e.g., possibly use Delta-E from paper as proxy for visual appearance). Note that the term ‘halftone’ as utilized herein can relate to a reprographic technique that can simulate continuous-tone imagery through the use of dots, varying either in size or in spacing, thus generating a gradient-like effect. The term ‘halftone’ can also relate to the image that can be produced by this process.

Next, as depicted at block 313, a step or operation can be implemented to automatically correlate value pairs across the various halftones having an equivalent visual appearance. Thereafter, as shown at block 314, using THOSE values, a step or operation can be implemented to automatically produce a second single page tone ramp patch page using the well hiding pairs for a particular halftone pair (e.g., could fit several on a single page). Next, as indicated at block 315, a step or operation can be implemented to copy the second single page tone ramp patch page on the various copiers/settings, followed be a step or operation, as depicted at block 316, to automatically measure and record those results.

Then, as shown at block 317, a step or operation can be implemented to automatically find those pairs with contrast improvement (e.g., one or the other member of a pair gets darker or lighter, increasing apparent contrast between them above the pre-set or user defined “is well revealed after copy” threshold). Thereafter, as illustrated at block 318, a step or operation can be implemented to automatically generate a final, single, minimal visual swatch set file to be printed on an original printer and copied on copiers for final visual confirmation/selection of winners. For a case of 7 “colors” and 4 VOID halftone options, this can reduce the original print set for only from, for example, 476 pages per media to 28, and the copied output from 3332 pages per media, to less than 100, and reduce the evaluation time accordingly.

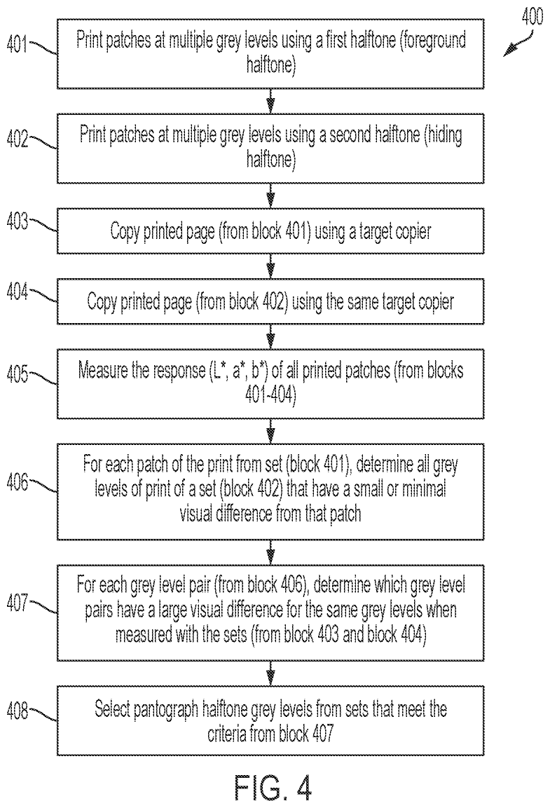

FIG. 4 illustrates a flow chart of operations depicting logical operational steps of a method 400 for automated calibration optimized patch set creation for a void pantograph, in accordance with another embodiment. The method 400 shown in FIG. 4 and the method 300 depicted in FIG. 3 represents variations on the same theme. That is, the method 300 and the method 400 offer slightly different approaches to achieving the same goal, namely, automatically calibrating first generation prints and post-copy results of pantograph pattern samples to drastically reduce the time and labor involved in optimizing void pantograph designs for a particular print condition, as compared to conventional solutions such as discussed in the background section of this disclosure.

As shown at block 401, a step or operation can be implemented to print patches at multiple grey levels using a first halftone (foreground halftone). Next, as shown at block 402, a step or operation can be implemented to print patches at multiple grey levels using a second halftone (hiding halftone). Then, as shown at block 403, a step or operation can be implemented to copy the printed page (of block 401) using a target copier. As depicted next at block 404, a step or operation can be implemented to copy the printed page (of block 402) using the same target copier.

As shown at block 405, a step a step or operation can be implemented to measure the response (L*, a*, b*) of all printed patches (from blocks 401-404). As depicted next at block 406, for each patch of the print from set (block 401), a step or operation can be implemented to determine all grey levels of print of a set (block 402) that have a small or minimal visual difference (e.g. <1 delta E) from that patch. For example, for a grey level in the foreground halftone=40% (from PRINT in block 401), hiding halftone grey levels of 60% and 70% (from PRINT in block (402) are within 1 delta E.

As depicted next at block 407, for each grey level pair (from block 406), a step or operation can be implemented for determining which grey level pairs have a large visual difference (e.g. >4 delta E) for the same grey levels when measured with sets (block 403) and (block 404), i.e., THE COPY. For example, from the set determined as shown in block 406, 40% grey level of the foreground halftone from the COPY (from block (403) is 3 deltaE (<4) different from hiding halftone of grey level 60% from the COPY (from block (404)). From the same set, 40% grey level of the foreground halftone from the COPY (from step (3)) may be 5 deltaE (>4) different from a hiding halftone of grey level 70% from the COPY (from block 404). In the above example, only foreground halftone of 40% grey level and hiding halftone of grey level of 70% have the printed grey levels within 1 deltaE and the copy grey levels more than 1 delta E. This pair can be suitable for pantograph hiding.

As shown next at block 408, a step or operation can be implemented to select pantograph halftone grey levels from sets that meet the criteria from block 407. It is recommend that it may be best to select halftones with the largest deltaE difference between the copies.

The disclosed method(s) can be summarized as follows:
1) Printing patches at multiple gray levels using a first halftone (foreground halftone)
2) Printing patches at multiple gray levels using a second halftone. (hiding halftone)
3) Copying the printed page of (1) using a target copier
4) Copying the printed page of (2) using the same target copier
5) Measuring the response (L*, a*, b*) of all printed patches (from steps 1-4)
6) For each patch of the print from set (1) determine all gray levels of print of set (2) that have a small visual difference (e.g. <1 delta E) from that patch
   a. EXAMPLE—for a gray level in the foreground halftone=40% (from PRINT in (1)) , hiding halftone gray levels of 60% and 70% (from PRINT in step(2)) are within 1 delta E
7) For each gray level pair set from step (6) determining which ones have a large visual difference (e.g. >4 delta E) for the same gray levels when measured with sets (3) and (4)—THE COPY
   a. From the set in 6a—40% gray level of the foreground halftone from the COPY (from step (3)) is 3 deltaE (<4) different from hiding halftone of gray level 60% from the COPY (from step (4))
   b. From the set in 6a—40% gray level of the foreground halftone from the COPY (from step (3)) is 5 deltaE (>4) different from hiding halftone of gray level 70% from the COPY (from step (4))
   c. In the above example, only foreground halftone of 40% gray level and hiding halftone of gray level of 70% have the printed gray levels within 1 deltaE and the copy gray levels more than 1 delta E. This pair is suitable for pantograph hiding
8) Choose pantograph halftone gray levels from sets that meet the criteria of (7). Probably best to choose halftones with the largest deltaE difference between the copies.

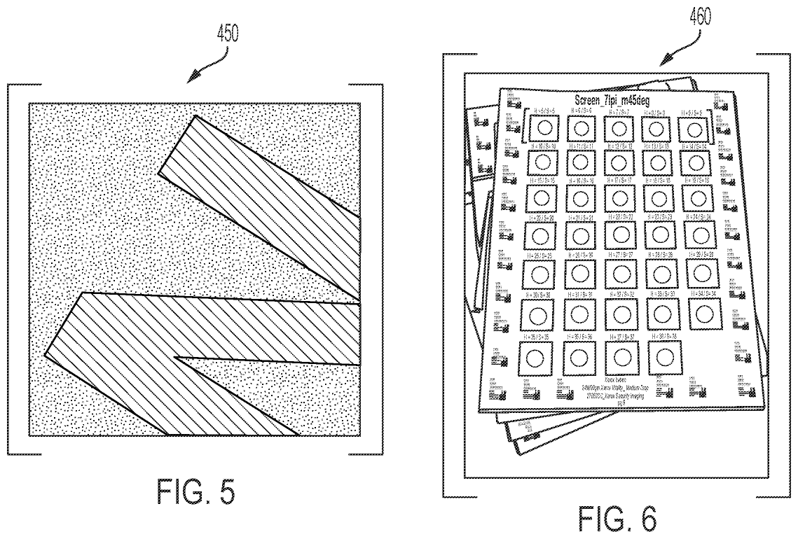

FIG. 5 illustrates an image 450 representative of an enlarged example of a well-hiding and strongly-revealing pantograph using black ink, tones of 29% and 22%, and two different halftones, and a particular media and drop size, in accordance with an embodiment. Note that in the printed originally, the letter N (here rotated) is ‘well-hidden’ in the grey field, but after coping, reveals strongly on some copiers.

FIG. 6 illustrates an image 460 representative of the historically time- and labor-intensive process, in which a partial set of original prints with several “well-hiding” swatches selected after manual visual evaluation.

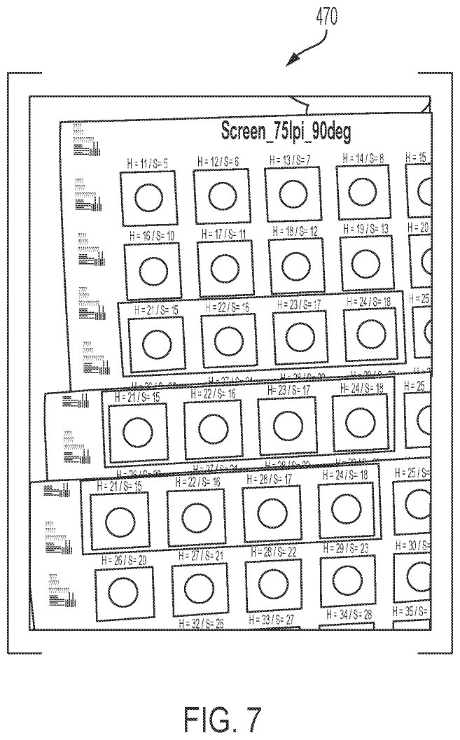

FIG. 7 illustrates an image 470 demonstrating the use of the prior process, in the back a selection of well-hidden Halftone pairs, on top of that those same pairs showing as strongly revealed on a particular Black and White copier, and on top of that those same pairs showing as strongly revealed on a particular Color Copier (after manually visually selection).

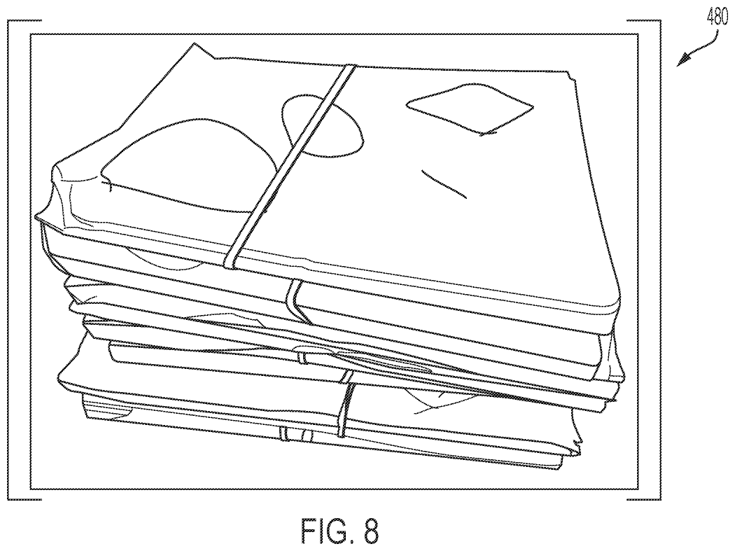

FIG. 8 illustrates an image 480 of one set of copy samples after discarding HALF as poor performers.

Based on the foregoing, it can be appreciated that a number of embodiments are disclosed herein including preferred embodiments and alternative embodiments. For example, in an embodiment, a method for creating a security mark for a document, can involve: rendering a first generation print based on at least one pattern for a security mark; rendering post-copy results of the at least one pattern; and calibrating the first generation print and the post-copy results of the at least one pattern, wherein an output of the calibrating of the first generation print and the post-copy results is applicable for optimizing a design of the security mark for a print condition.

An embodiment of the method can further involve optimizing the design of the security mark for a print condition by applying the output of the calibrating of the first generation print and the post-copy results for the print condition.

An embodiment of the method can also involve rendering a first generation print based on the at least one pattern for a security mark, further comprises: printing a first patch at multiple grey levels using a first halftone.

An embodiment of the method can further involve rendering post-copy results of the at least one pattern, further comprises: printing a second patch at multiple grey levels using a second haltone.

In an embodiment, the first generation print and the post-copy results of the at least one pattern, can further involve: copying a first printed page comprising the first patch using a target copier; copying a second printed page comprising the second patch using the target copier; measuring a response of the first printed page including the first patch and the second printed page including the second patch; determining all grey levels having a minimal visual difference with respect to each of the first patch and second patch; and determining which grey levels have a large visual difference with respect to each of the first patch and second patch when measured with copies of the first printed page and the second printed page.

An embodiment of the method can further involve selecting a plurality of pantograph halftone grey levels for optimizing a design of the security mark for a print condition based on the determined grey levels having the large visual difference.

In another embodiment, a system for creating a security mark for a document can include at least one processor, and a non-transitory computer-usable medium embodying computer program code. The computer-usable medium can be configured or can be operable for communicating with the at least one processor. The computer program code can include instructions executable by the at least one processor and configured for: rendering a first generation print based on at least one pattern for a security mark; rendering post-copy results of the at least one pattern; and calibrating the first generation print and the post-copy results of the at least one pattern, wherein an output of the calibrating of the first generation print and the post-copy results is applicable for optimizing a design of the security mark for a print condition.

In an embodiment of the system, the instructions executable by the at least one processor can be further configured for: optimizing the design of the security mark for a print condition by applying the output of the calibrating of the first generation print and the post-copy results for the print condition.

In an embodiment of the system, the instructions executable by the at least one processor can be further configured for: rendering a first generation print based on the at least one pattern for a security mark, further comprises: printing a first patch at multiple grey levels using a first halftone.

In an embodiment of the system, the instructions executable by the at least one processor can be further configured for: rendering post-copy results of the at least one pattern, further comprises: printing a second patch at multiple grey levels using a second haltone.

In an embodiment of the system, the instructions configured for calibrating the first generation print and the post-copy results of the at least one pattern, can further comprise instructions configured for: copying a first printed page comprising the first patch using a target copier; copying a second printed page comprising the second patch using the target copier; measuring a response of the first printed page including the first patch and the second printed page including the second patch; determining all grey levels having a minimal visual difference with respect to each of the first patch and second patch; and determining which grey levels have a large visual difference with respect to each of the first patch and second patch when measured with copies of the first printed page and the second printed page.

In an embodiment of the system, the instructions executable by the at least one processor can be further configured for: selecting a plurality of pantograph halftone grey levels that optimize a design of the security mark for a print condition based on the determined grey levels having the large visual difference.

In another embodiment, an apparatus that provides security for a document, can include: a security mark based on a first generation print rendered based on at least one pattern for a security mark and further based on post-copy results rendered of the at least one pattern, wherein the output of a calibration of the first generation print and the post-copy results can be applicable for optimizing the design of the security mark for a print condition.

In an embodiment of the apparatus, the design of the security mark for a print condition can be optimized by applying the output of the calibration of the first generation print and the post-copy results for the print condition.

In an embodiment of the apparatus, the first generation print based on the at least one pattern for a security mark can be rendered by printing a first patch at multiple grey levels using a first halftone.

In an embodiment of the apparatus, the first generation print based on the at least one pattern for a security mark, can be rendered by printing a first patch at multiple grey levels using a first halftone, and the post-copy results of the at least one pattern can be rendered by printing a second patch at multiple grey levels using a second haltone.

In an embodiment of the apparatus, the calibration of the first generation print and the post-copy results of the at least one pattern can be achieved by copying a first printed page comprising the first patch using a target copier; copying a second printed page comprising the second patch using the target copier; measuring a response of the first printed page including the first patch and the second printed page including the second patch; determining all grey levels having a minimal visual difference with respect to each of the first patch and second patch; and determining which grey levels have a large visual difference with respect to each of the first patch and second patch when measured with copies of the first printed page and the second printed page.

In an embodiment of the apparatus, a plurality of pantograph halftone grey levels can be selectable for optimizing the design of the security mark for the print condition based on the determined grey levels having the large visual difference.

Note that although the operations of the method(s) herein are shown and described in a particular order, the order of the operations of each method may be altered so that certain operations may be performed in an inverse order or so that certain operations may be performed, at least in part, concurrently with other operations. In another embodiment, instructions, steps, operations or sub-operations of distinct operations may be implemented in an intermittent and/or alternating manner.

It should also be noted that at least some of the operations for the methods and systems described herein may be implemented using software instructions stored on a computer useable storage medium for execution by a computer. As an example, an embodiment of a computer program product can include a computer useable storage medium to store a computer readable program.

Alternatively, embodiments of the invention may be implemented entirely in hardware or in an implementation containing both hardware and software elements. In embodiments that do utilize software, the software may include but is not limited to firmware, resident software, microcode, etc.

In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A method for creating a security mark for a document, comprising:
rendering a first generation print based on at least one pattern for a security mark;
rendering post-copy results of the at least one pattern;
calibrating the first generation print and the post-copy results of the at least one pattern, wherein the calibrating includes a determined correlation between the first generation print and the post-copy results of the at least one pattern; and
utilizing an output of the calibrating of the first generation print and the post-copy results to optimize a design of the security mark for a print condition.

2. The method of claim 1 further comprising optimizing the design of the security mark for the print condition by applying the output of the calibrating of the first generation print and the post-copy results for the print condition.

3. The method of claim 1 further comprising:
rendering a first generation print based on the at least one pattern for a security mark, further comprises: printing a first patch set using a first halftone type.

4. The method of claim 3 further comprising:
rendering post-copy results of the at least one pattern, further comprises: printing a second patch set using a second halftone type.

5. The method of claim 1 wherein:
rendering a first generation print based on the at least one pattern for a security mark, further comprises: printing a first patch set using a first halftone type; and
rendering post-copy results of the at least one pattern, further comprises: printing a second patch set using a second halftone type.

6. The method of claim 5 wherein calibrating the first generation print and the post-copy results of the at least one pattern, further comprises:
copying a first printed page comprising the first patch set using a target copier;
copying a second printed page comprising the second patch set using the target copier;
measuring a color space response of the first printed page including the first patch set and the second printed page including the second patch set,
determining all grey levels having a minimal visual difference with respect to each of the first patch set and the second patch set; and
determining which grey levels have a large visual difference with respect to each of the first patch set and the second patch set when measured with copies of the first printed page and the second printed page.

7. The method of claim 6 further comprising:
automatically correlating value pairs across the halftones having an equivalent visual appearance; and
selecting a plurality of pantograph halftone grey levels for optimizing the design of the security mark for the print condition based on the determined grey levels having the large visual difference.

8. A system for creating a security mark for a document, comprising:
at least one processor; and
a non-transitory computer-usable medium embodying computer program code, the computer-usable medium capable of communicating with the at least one processor, the computer program code comprising instructions executable by the at least one processor and configured for:
rendering a first generation print based on at least one pattern for a security mark;
rendering post-copy results of the at least one pattern; and
calibrating the first generation print and the post-copy results of the at least one pattern, wherein the calibrating includes a determined correlation between the first generation print and the post-copy results of the at least one pattern, wherein an output of the calibrating of the first generation print and the post-copy results is applicable for optimizing a design of the security mark for a print condition.

9. The system of claim 8 wherein the instructions executable by the at least one processor are further configured for:
optimizing the design of the security mark for a print condition by applying the output of the calibrating of the first generation print and the post-copy results for the print condition.

10. The system of claim 8 wherein:
rendering a first generation print based on the at least one pattern for a security mark, further comprises: printing a first patch set at using a first halftone type comprising a foreground halftone.

11. The system of claim 10 wherein
rendering post-copy results of the at least one pattern, further comprises: printing a second patch set at multiple grey levels using a second halftone type comprising a hiding halftone.

12. The system of claim 8 wherein:
rendering a first generation print based on the at least one pattern for a security mark, further comprises: printing a first patch set using a first halftone type; and
rendering post-copy results of the at least one pattern, further comprises: printing a second patch using a second halftone type.

13. The system of claim 12 wherein the instructions configured for calibrating the first generation print and the post-copy results of the at least one pattern, further comprises instructions configured for:
copying a first printed page comprising the first patch set using a target copier;
copying a second printed page comprising the second patch set using the target copier;
measuring a color space response of the first printed page including the first patch set and the second printed page including the second patch set;
determining all grey levels having a minimal visual difference with respect to each of the first patch set and second patch set; and
determining which grey levels have a large visual difference with respect to each of the first patch set and second patch set when measured with copies of the first printed page and the second printed page.

14. The system of claim 13 wherein the instructions executable by the at least one processor are further configured for:
automatically correlating value pairs across the halftones having an equivalent visual appearance; and
selecting a plurality of pantograph halftone grey levels that optimize the design of the security mark for the print condition based on the determined grey levels having the large visual difference.

15. An apparatus that provides security for a document, comprising:
a security mark based on a first generation print rendered based on at least one pattern for a security mark and further based on post-copy results rendered of the at least one pattern; and
wherein an output of a calibration of the first generation print and the post-copy results is used to optimize a design of the security mark for a print condition and wherein the calibration includes a determined correlation between the first generation print and the post-copy results of the at least one pattern.

16. The apparatus of claim 15 wherein the design of the security mark for a print condition is optimized by applying the output of the calibration of the first generation print and the post-copy results for the print condition.

17. The apparatus of claim 15 wherein the first generation print rendered based on the at least one pattern for a security mark, is configured by printing a first patch at multiple grey levels using a first halftone.

18. The apparatus of claim 15 wherein:
the first generation print based on the at least one pattern for a security mark, is rendered by printing a first patch at multiple grey levels using a first halftone type comprising a foreground halftone; and
the post-copy results of the at least one pattern are rendered by printing a second patch at multiple grey levels using a second halftone type comprising a hiding halftone.

19. The apparatus of claim 18 wherein the calibration of the first generation print and the post-copy results of the at least one pattern, comprises:
copying a first printed page comprising the first patch using a target copier;
copying a second printed page comprising the second patch using the target copier;
measuring a color space response of the first printed page including the first patch and the second printed page including the second patch;
determining all grey levels having a minimal visual difference with respect to each of the first patch and second patch; and
determining which grey levels have a large visual difference with respect to each of the first patch and second patch when measured with copies of the first printed page and the second printed page.

20. The apparatus of claim 19 further comprising:
a plurality of pantograph halftone grey levels selectable for optimizing the design of the security mark for the print condition based on the determined grey levels having the large visual difference, wherein value pairs are automatically correlated across the halftones having an equivalent visual appearance.
